(19) United States
(12) Patent Application Publication
(10) Pub. No.: US 2019/0295121 A1
(43) Pub. Date: Sep. 26, 2019

(54) METHOD AND SYSTEM FOR DETERMINING AN OPTIMUM PROMOTION SEQUENCE FOR AN ENTERPRISE

(71) Applicant: Wipro Limited, Bangalore (IN)

(72) Inventors: Saju Ramachandran, Bangalore (IN); Srinidhi Srinivasan, Bangalore (IN)

(21) Appl. No.: 15/937,479

(22) Filed: Mar. 27, 2018

(30) Foreign Application Priority Data
Mar. 21, 2018 (IN) 201841010332

(51) Int. Cl. G06Q 30/02

(52) U.S. Cl. CPC G06Q 30/0244; G06Q 30/0247

(57) ABSTRACT

The present disclosure discloses method and optimum promotion determination system for determining optimum promotion sequence for enterprise. The optimum promotion determination system receives details of plurality of promotion activities to be organized in each month of predefined year from user, generates gain matrix for predefined year using one of historic gain values and user-defined gain values for each of plurality of promotion activities, generates constraint matrix based on values of plurality of causal factors defined by user for each month of predefined year along with number of promotion activities to be organized in each month of predefined year. The optimum promotion determination system identifies plurality of promotion sequences using predefined technique along with gain value for each promotion sequences based on constraint matrix and gain matrix. Thereby, determining, optimum promotion sequence for predefined year, from plurality of promotion sequences, based on gain value of plurality of promotion sequences.

This application claims the benefit of Indian Patent Application Serial No. 201841010332, filed Mar. 21, 2018, which is hereby incorporated by reference in its entirety.

### FIELD

The present subject matter is related in general to promotion management, more particularly, but not exclusively to method and system for determining an optimum promotion sequence for an enterprise.

### BACKGROUND

Today, promotion activities are a key instrument for driving sales and profits in every industry. Every enterprise commonly employs promotion activities to improve profits, revenues, sales volumes, and the like. For instance, an enterprise may adjust prices as needed to encourage sales of products. With ever increase in advanced products and services available in market today, frequent trade promotions and campaigns are becoming common to increase sales revenue. It is highly probable that a promotion can have a negative impact on the sales revenue, unless properly planned. In other words, promotion planning, and optimization are buzz words which revolves around enterprise revenue strategies.

In existing system, promotion optimization is a challenging problem as retailers need to decide which products to promote, what is the depth of price discounts and finally, when to schedule the promotions. Generally, it becomes very difficult to plan promotion activities and pricing adjustments to meet enterprise-specific objectives. Typically, in a calendar year of enterprises, there would be thousands of promotions planned. It is imperative and difficult for the enterprises in the existing system to outline and identify significant promotion and month combinations which would result in optimal revenue. Besides promotions resulting in cannibalization, it would also lead to decrease in profits due to associated promotion costs. Thus, an analytical platform is required to model promotions and produce most optimal promotion-month combination resulting in revenue maximization with minimal manual intervention.

The information disclosed in this background of the disclosure section is only for enhancement of understanding of the general background of this technology and should not be taken as an acknowledgement or any form of suggestion that this information forms the prior art already known to a person skilled in the art.

### SUMMARY

In an embodiment, the present disclosure may relate to a method of determining an optimum promotion sequence for an enterprise. The method comprises receiving details of a plurality of promotion activities to be organized, in the enterprise, in each month of a predefined year, from a user, generating a gain matrix for the predefined year using one of, historic gain values and user-defined gain values for each of the plurality of promotion activities, generating a constraint matrix, based on values of a plurality of causal factors defined by the user for each month of the predefined year along with number of promotion activities to be organized in each month of the predefined year, identifying a plurality of promotion sequences, using a predefined technique, for the predefined year along with a gain value for each promotion sequence, based on the constraint matrix and the gain matrix. The plurality of promotion sequences comprises one or more promotion activities from the plurality of promotion activities for each month of the predefined year and determining the optimum promotion sequence for the predefined year, from the plurality of promotion sequences, based on the gain value of the plurality of promotion sequences.

In an embodiment, the present disclosure may relate to an optimum promotion determination system for determining an optimum promotion sequence for an enterprise. The optimum promotion determination system may comprise a processor and a memory communicatively coupled to the processor, where the memory stores processor executable instructions, which, on execution, may cause the optimum promotion determination system to receive details of a plurality of promotion activities to be organized, in an enterprise, in each month of a predefined year, from a user, generate a gain matrix for the predefined year using one of, historic gain values and user-defined gain values for each of the plurality of promotion activities, generate a constraint matrix, based on values of a plurality of causal factors defined by the user for each month of the predefined year along with number of promotion activities to be organized in each month of the predefined year. The optimum promotion determination system identifies a plurality of promotion sequences, using a predefined technique, for the predefined year along with a gain value for each promotion sequence, based on the constraint matrix and the gain matrix. The plurality of promotion sequences comprises one or more promotion activities from the plurality of promotion activities for each month of the predefined year. The optimum promotion determination system determines the optimum promotion sequence for the predefined year, from the plurality of promotion sequences, based on the gain value of the plurality of promotion sequences.

In an embodiment, the present disclosure relates to a non-transitory computer readable medium including instructions stored thereon that when processed by at least one processor may cause an optimum promotion determination system to receive details of a plurality of promotion activities to be organized, in an enterprise, in each month of a predefined year, from a user, generate a gain matrix for the predefined year using one of, historic gain values and user-defined gain values for each of the plurality of promotion activities, generate a constraint matrix, based on values of a plurality of causal factors defined by the user for each month of the predefined year along with number of promotion activities to be organized in each month of the predefined year. The instruction causes the processor to identify a plurality of promotion sequences, using a predefined technique, for the predefined year along with a gain value for each promotion sequence, based on the constraint matrix and the gain matrix. The plurality of promotion sequences comprises one or more promotion activities from the plurality of promotion activities for each month of the predefined year. The instruction causes the processor to determine the optimum promotion sequence for the predefined year, from the plurality of promotion sequences, based on the gain value of the plurality of promotion sequences.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for determining an optimum promotion sequence for an enterprise in accordance with some embodiments of the present disclosure;

FIG. 2 shows a detailed block diagram of an optimum promotion determination system in accordance with some embodiments of the present disclosure;

FIG. 3 show an exemplary representation for determining an optimum promotion sequence for an enterprise in accordance with some embodiments of the present disclosure;

FIG. 4 illustrates a flowchart showing a method for determining an optimum promotion sequence for an enterprise in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method and an optimum promotion determination system for determining an optimum promotion sequence for an enterprise. In an embodiment, the enterprise may refer to an organization providing products and services and encompasses corporations, small businesses, non-profit institutions, government bodies, and possibly other kinds of organizations. In an embodiment, the enterprise may promote their products and services using a plurality of promotion activities. The optimum promotion determination system may receive details of the plurality of promotion activities to be organized in the enterprise from a user. A gain matrix representing a collective list of the plurality of promotion activities with respective gain value for each month of a predefined year may be generated for a predefined year using one of historic gain values and user-defined gain values. Additionally, a constraint matrix may be generated based on values of a plurality of causal factors defined by the user for each month of the predefined year along with number of promotion activities to be organized in each month of the predefined year. A plurality of promotion sequences may be identified for the predefined year along with a gain value for each promotion sequence based on the constraint matrix and the gain matrix. In an embodiment, the plurality of promotion sequences includes one or more promotion activities from the plurality of promotion activities for each month of the predefined year. Thereafter, an optimum promotion sequence for the predefined year may be determined based on the gain value of the plurality of promotion sequences. The present disclosure helps in selecting optimal promotions with optimal promotion costs.

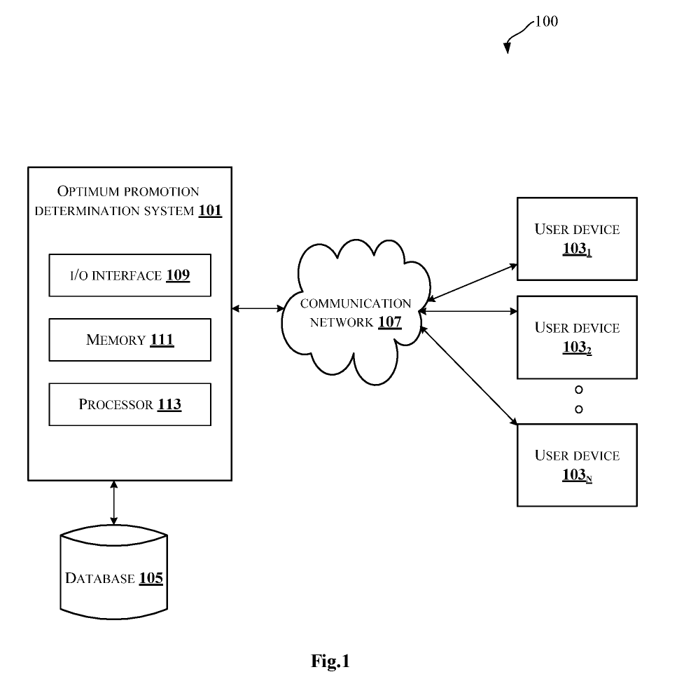

FIG. 1 illustrates an exemplary environment for determining an optimum promotion sequence for an enterprise in accordance with some embodiments of the present disclosure.

As shown in FIG. 1, an environment 100 includes an optimum promotion determination system 101 connected through a communication network 107 to a user device 103₁, a user device 103₂ . . . and a user device 103_{N} (collectively referred as plurality of user devices 103). In an embodiment, the plurality of user devices 103 may include a platform which has an ability to incorporate syndicated data as well as retailer direct Point of Sale (POS) data from one or more sources. A person skilled in the art would understand that, any other user devices, not mentioned explicitly, may also be used in the present disclosure. Further, the communication network 107 may include, but is not limited to, a direct interconnection, an e-commerce network, a Peer to Peer (P2P) network, Local Area Network (LAN), Wide Area Network (WAN), wireless network (for example, using Wireless Application Protocol), Internet, Wi-Fi and the like. The optimum promotion determination system 101 includes an I/O interface 109, a memory 111, and a processor 113. Further, the optimum promotion determination system 101 is connected to a database 105. The database 105 may store the data received from the plurality of user devices 103.

The optimum promotion determination system 101 determines an optimum promotion sequence for the enterprise. In an embodiment, the optimum promotion determination system 101 may include, but is not limited to, a laptop, a desktop computer, a Personal Digital Assistant (PDA), a notebook, a smartphone, a tablet, a server, and any other computing devices. A person skilled in the art would understand that, any other devices, not mentioned explicitly, may also be used as the optimum promotion determination system 101 in the present disclosure. The optimum promotion determination system 101 may receive details of a plurality of promotion activities to be organized in the enterprise in each month of a predefined year from the plurality of user devices 103. In an embodiment, the plurality of promotion activities represents a set of activities for presenting details of services provided by the enterprise through one or more mediums. In an embodiment, the predefined year may include a calendar year. The optimum promotion determination system 101 may generate a gain matrix for the predefined year using one of historic gain values and user-defined gain values for each of the plurality of promotion activities. In an embodiment, the historic gain values may be obtained based on gain values assigned against each of the plurality of promotion activities previously. In an embodiment, the user-defined gain values may include the gain values defined by user based on historic gain values. In an embodiment, the gain matrix may represent a collective list of the plurality of promotion activities with respective gain value for each month of the predefined year.

Further, the optimum promotion determination system 101 may generate a constraint matrix based on values of a plurality of causal factors defined by the user for each month of the predefined year along with number of promotion activities to be organized in each month of the predefined year. In an embodiment, the causal factors are parameters associated with the plurality of promotion activities. In an embodiment, the optimum promotion determination system 101 may regenerate the constraint matrix when the user changes the one or more promotion activities of the plurality of promotion activities for a month. The optimum promotion determination system 101 may identify a plurality of promotion sequences for the predefined year using a predefined technique, along with a gain value for each promotion sequence based on the constraint matrix and the gain matrix. In an embodiment, the predefined technique may include Integer Linear Programming (ILP) optimization technique. A person skilled in the art would understand that, any technique, not mentioned explicitly, may also be used in the present disclosure. In an embodiment, the plurality of promotion sequences includes one or more promotion activities from the plurality of promotion activities for each month of the predefined year. The optimum promotion determination system 101 may determine the optimum promotion sequence for the predefined year from the plurality of promotion sequences, based on the gain value of the plurality of promotion sequences. In an embodiment, the optimum promotion determination system 101 may identify a predefined set of maximum gain values from the gain value of the plurality of promotion sequences and selects one gain value from the predefined set of maximum gain values. The optimum promotion determination system 101 may determine the optimum promotion sequence from the plurality of promotion sequences based on the selected gain value.

The I/O interface 109 may be configured to receive details of the plurality of promotion activities from the plurality of user devices 103. The I/O interface 109 may receive the historic gain values associated with the plurality of promotion activities. Further, the I/O interface 109 may provide details of the optimum promotion sequence to the plurality of user devices 103.

The information received from the I/O interface 109 may be stored in the memory 111. The memory 111 may be communicatively coupled to the processor 113 of the optimum promotion determination system 101. The memory 111 may also store processor instructions which may cause the processor 113 to execute the instructions for determining an optimum promotion sequence for an enterprise.

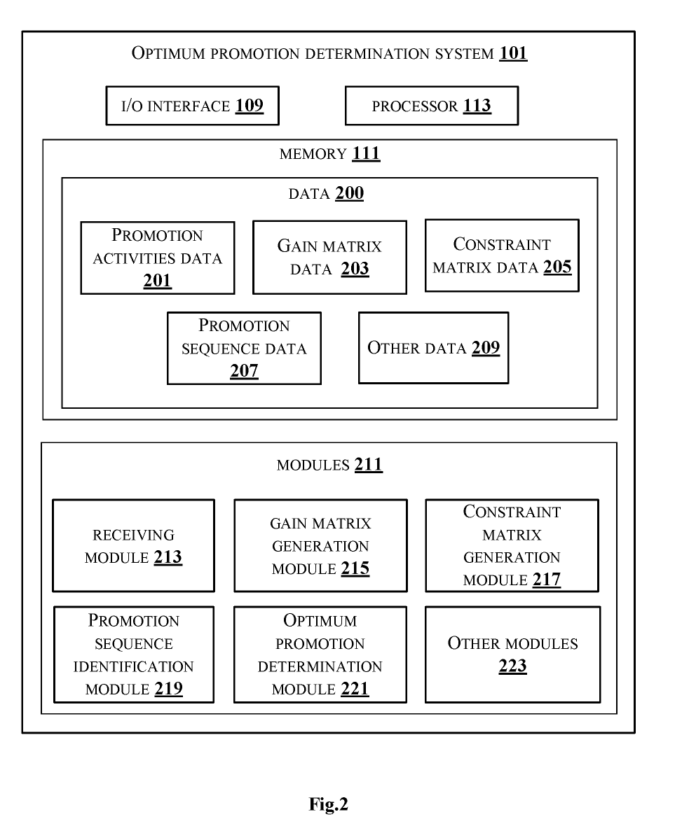

FIG. 2 shows a detailed block diagram of the optimum promotion determination system 101 in accordance with some embodiments of the present disclosure.

Data 200 and one or more modules 211 of the optimum promotion determination system 101 are described herein in detail. In an embodiment, the data 200 may include promotion activities data 201, gain matrix data 203, constraint matrix data 205, promotion sequence data 207 and other data 209.

The promotion activities data 201 may include the plurality of promotion activities which may be organized in the enterprise for the predefined year. The plurality of promotion activities may include various types of promotion activities to be organized for the predefined year. For example, the various types of promotion activities may include, but are not limited to, buy one get one free, free gift, pay only one dollar, pay 50 percent, and the like.

The gain matrix data 203 may include details of the gain values based on which the gain matrix may be generated. In an embodiment, the gain values may represent profits which the enterprise may generate by organizing the plurality of promotion activities. The gain matrix data 203 may include details about the historic gain values assigned to the plurality of promotion activities previously. Further, the gain matrix data 203 may include the user-defined gain value. In an embodiment, based on the historic gain values, users may define the gain values for the plurality of promotion activities.

The constraint matrix data 205 may include details about the plurality of causal factors defined by the user for each month of the predefined year. The constraint matrix data 205 may include the values defined by the user for each of the plurality of causal factors. In an embodiment, the plurality of causal factors may be parameters associated with the plurality of promotion activities. The plurality of causal may include such as, sales, brand, promotion revenue, week promotion, month promotion, catalogue, and the like. A person skilled in the art would understand that any other causal factors, not mentioned explicitly, may be used in association with the plurality of promotion activities in the present disclosure.

The promotion sequence data 207 may include details of the plurality of promotion sequences identified for each month of the predefined year. The promotion sequence data 207 may also include the gain values associated with each sequence of the plurality of promotion sequences.

The other data 209 may store data, including temporary data and temporary files, generated by modules 211 for performing the various functions of the optimum promotion determination system 101.

In an embodiment, the data 200 in the memory 111 are processed by the one or more modules 211 of the optimum promotion determination system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The modules 211 when configured with the functionality defined in the present disclosure will result in a novel hardware.

In one implementation, the modules 211 may include, but are not limited to a receiving module 213, a gain matrix generation module 215, a constraint matrix generation module 217, a promotion sequence identification module 219 and an optimum promotion determination module 221. The one or more modules 211 may also include other modules 223 to perform various miscellaneous functionalities of the optimum promotion determination system 101. In an embodiment, the other modules 223 may include a filtering module for filtering the plurality of promotion activities received from the plurality of user devices 103 by removing redundant promotion activities.

The receiving module 213 may receive the details of the plurality of promotion activities which are to be organized in the enterprise, from the plurality of user devices 103. In an embodiment, the plurality of promotion activities may refer to the set of activities which may be used for presenting details of services provided by the enterprise through one or more mediums. For instance, the promotion activities may include, save 2×, free gift, pay 50 percent, pay one get one free, buy two get two free and the like. A person skilled in the art would understand that any other promotion activities, not mentioned explicitly, may also be used in the present disclosure. The receiving module 213 may receive a number of promotion activities planned over the predefined year for each month. Further, the receiving module may receive the historic gain values associated with each of the plurality of promotion activities from the database 105.

The gain matrix generation module 215 may generate the gain matrix for the predefined year using one of the historic gain values and the user-defined gain values for each of the plurality of promotion activities. In an embodiment, the gain matrix represents the collective list of the plurality of promotion activities with respective gain value for each month of the predefined year. Table 1 below shows a gain matrix generated based on the historic gain values.

TABLE 1

| | month | | | | | | |
|---|---|---|---|---|---|---|---|
| Promotion | January | February | March | April | May | June | |
| Save2xs | 5 | 10 | 11 | 16 | 9 | 7 | Gain |
| Save 3x | 19 | 12 | 19 | 4 | 19 | 19 | value |
| Save 5x | 9 | 19 | 10 | 17 | 15 | 19 | |
| Save 4x | 6 | 3 | 9 | 10 | 7 | 13 | |
| Buy 2 for 1 | 4 | 10 | 5 | 13 | 1 | 16 | |
| Buy 3 for 1 | 9 | 12 | 16 | 5 | 9 | 18 | |
| Buy 4 for 1 | 3 | 16 | 19 | 10 | 5 | 15 | |
| Free gift | 15 | 12 | 7 | 18 | 17 | 3 | |
| Pay 50% | 10 | 10 | 6 | 10 | 17 | 7 | |
| Pay 25% | 13 | 16 | 8 | 12 | 2 | 7 | |
| Save 1.5x | 6 | 18 | 19 | 5 | 6 | 14 | |
| Pay on 1.99$ | 2 | 7 | 11 | 5 | 4 | 4 | |
| Save 1.25x | 9 | 13 | 8 | 9 | 5 | 18 | |

As shown in the Table 1, the gain matrix dislcoses first six months of a year with thirteen promotion activities along with gain value for each promotion activities with respect to each month. As shown, promotion activity ‘save 2×’ may generate a gain value of $5 in January, and $7 in June. Similarly, promotion activity ‘save 5×’ may generate a gain value of $19 in February, $15 in May and the like. In an embodiment, the gain matrix in Table 1 may be mathematically represented as:

P₁M₁=5;P₂M₁₀=P₂M₁₂=P₃M₉=15 (1)

Where, P1, P2, P3 and M1, M2 and M3 represent different promotion activity and month respectively.

The constraint matrix generation module 217 may generate the constraint matrix based on values of the plurality of causal factors defined by the user for each month of the predefined year along with number of promotion activities to be organized in each month of the predefined year. In an embodiment, after formulating the gain matrix, the number of promotion activities which may be required on a monthly basis may be identified by users. For example, if the historic gain values indicate that around 350 promotion activites may be organized in previous calendar year, the users may specify to organize 10 in January, 25 in February, 50 in March, 2 in April, 100 in December and so on. In an embodiment, values of plurality of causal factors such as, Ad sizes, mechanic, catalogue sizes and the like may be received from the plurality of user devices 103. Based on the values of the plurality of causal factors, the constraint matrix generation module 217 may generate the constraint matrix. In an embodiment, the values of the plurality of causal factors may be defined in binary format such that, an active causal factors is represented as “1” and an inactive causal factor is represented as “0” as shown in below Table 2. Table 2 shows a constraint matrix generated based on values of the plurality of causal factors received from the plurality of user devices 103.

TABLE 2

| Constraint | January | February | March | April | May | June | RHS |
|---|---|---|---|---|---|---|---|
| Number of | 1 | 0 | 0 | 0 | 0 | 0 | 2 |
| promotions | 0 | 1 | 0 | 0 | 0 | 0 | 3 |
| planned for | 0 | 0 | 1 | 0 | 0 | 0 | 4 |
| respective | 0 | 0 | 0 | 1 | 0 | 0 | 5 |
| month | 0 | 0 | 0 | 0 | 1 | 0 | 6 |
| | 0 | 0 | 0 | 0 | 0 | 1 | 7 |
| Adsize1 | 1 | 0 | 0 | 0 | 0 | 0 | 1 |
| Adsize2 | 0 | 1 | 0 | 1 | 1 | 0 | 1 |
| Catalogue1 | 0 | 0 | 1 | 0 | 0 | 1 | 1 |
| Catalogue2 | 0 | 0 | 0 | 1 | 0 | 1 | 1 |
| Mechanic | 0 | 0 | 10 | 0 | 1 | 1 | 1 |

The promotion sequence identification module 219 may identify the plurality of promotion sequences, using the predefined technique, for the predefined year along with a gain value for each promotion sequences. In an embodiment, the predefined technique may include the integer Linear Programming (ILP) optimization technique. In an embodiment, the promotion sequence identification module 219 may use any other technique, not mentioned explicitly in the present disclosure. In an embodiment, the plurality of promotion sequences includes one or more promotion activities from the plurality of promotion activities for each month of the predefined year. The promotion sequence identification module 219 may identify the plurality of promotion sequences, based on the constraint matrix and the gain matrix. In an embodiment, the promotion sequence identification module 219 may combine and analyze the gain matrix and the constraint matrix using a mix and match ILP technique. Below equation (2) shows a problem formulation example by considering two products:

$$Max Revenue ( R ) = Gross Revenue ( R = \sum {R}_{( \frac{promo}{month} )} ) - Cost ( C = \sum {C}_{\frac{promo}{month}} ) … objective function - revenue matrix generation \\ Subject to \text{:} Casual matrix \qquad ( 2 )$$

Table 3 below shows a promotion and month combination matrix which includes the plurality of promotion sequences along with gain value for each sequence. For example, as shown in Table 3, the promotion activity 2 and 18 is organized in January, 1, 5 and 15 in February and so on with the respected gain value, which is the overall expected optimal gain value. In Table 3 as shown below, five sets of causal factors are used and each promotion sequence includes a different gain value.

TABLE 3
Promotion and month combination

| | | | | | Gain | |
|---|---|---|---|---|---|---|
| January | February | March | April | May | value | |
| 2, 18 | 1, 5, 15 | 3, 6, 11, | 8, 10, 16, | 4, 9, 7, | 1721 | Each |
| | | 12 | 17, 20 | 13, 14, | | promotion |
| | | | | 19 | | |
| 3, 14 | 2, 9, 16 | 4, 6, 11, | 1, 8, 15, | 5, 7, 13, | 2122.6 | sequence |
| | | 12 | 10, 15, | 18, 19, | | with gain |
| | | | 17 | 20 | | |
| 1, 17 | 4, 6, 15 | 2, 9, 11, | 10, 12, | 3, 5, 7, | 3122.7 | value |
| | | 8 | 16, 18, | 13, 14, | | |
| | | | 20 | 19 | | |
| 4, 18 | 1, 9, 15 | 3, 6, 11, | 8, 10, 16, | 2, 5, 7, | 1514.5 | |
| | | 12 | 17, 20 | 13, 14, | | |
| | | | | 19 | | |

The optimum promotion determination module 221 may determine the optimum promotion sequence from the plurality of promotion sequences for the predefined year based on the gain value of the plurality of promotion sequences. The optimum promotion determination module 221 may identify a predefined set of maximum gain values from the gain value of the plurality of promotion sequence and may select one gain value from the predefined set of maximum gain values. Based on the selected gain value, the optimum promotion determination module 221 may determine the optimum promotion sequence from the plurality of promotion sequences. In Table 3, for example, two set of maximum gain values are identified as “2122.6” and “3122.7”. From the selected set of maximum gain value, the optimum promotion determination module 221 may select the gain value “3122.7” as the maximum gain value and may determine the third row in Table 3 as the optimum promotion sequence.

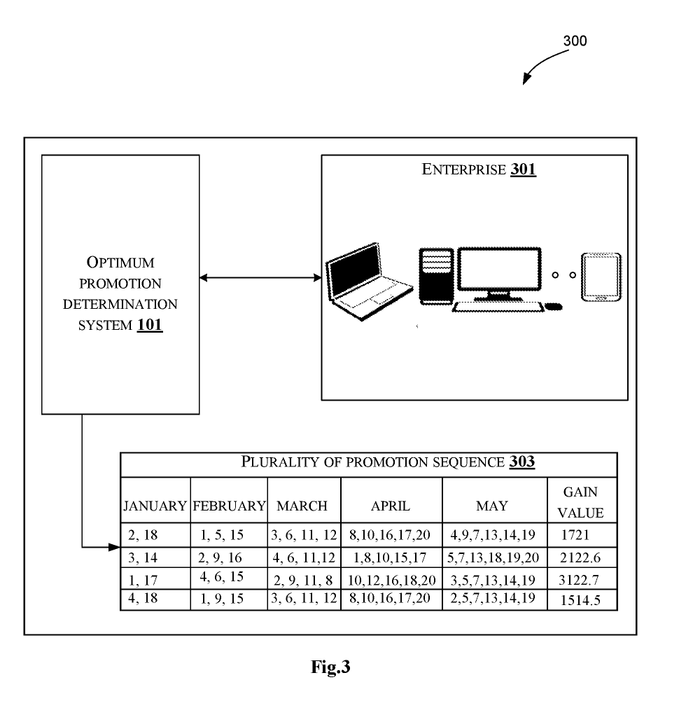

FIG. 3 shows an exemplary representation for determining an optimum promotion sequence for an enterprise in accordance with some embodiments of the present disclosure.

Referring now to FIG. 3, an exemplary representation 300 for determining optimum promotion sequence for the enterprise is illustrated. The exemplary representation 300 an enterprise 301, which is connected to the optimum promotion determination system 101. The enterprise 301 includes the plurality of user devices 103. The optimum promotion determination system 101 may initially receive the details of the plurality of promotion activities to be organized in the upcoming year from the plurality of user devices 103. For example, the optimum promotion determination system 101 receives five promotion activities such as, “buy one get one”, “pay 50 percent”, “save 2×”, “save 5” and free gift as the promotion activities to be organized in the upcoming year.

The optimum promotion determination system 101 may generate the gain matrix based on one of historic gain values and the user-defined gain values for each of the five promotion activities. In an embodiment, the gain matrix represents the collective list of the plurality of promotion activities with respective gain value for each month of the predefined year. For instance, the optimum promotion determination system 101 may generate the gain matrix based on the historic gain values associated with the five promotion activities. Consider, the historic gain values for the promotion activities, buy one, pay 50 percent, save 2×”, “save 5” and “free gift” are 5 dollars, 20 dollars, 5 dollars and 10 dollars respectively. In such case, the optimum promotion determination system 101 may generate the gain matrix based on the historic gain values of each of the five promotion activities. In an embodiment, the historic gain values may be received from the database 105 connected to the optimum promotion determination system 101 (not shown explicitly in FIG. 3). In an embodiment, users associated with the plurality of user devices 103 may define the values of plurality of causal factors. In an embodiment, the plurality of causal factors are the parameters of the plurality of promotion activites. For instance, five causal factors may be defined for the five promotion activities such as, sales, catalogue, adsize, brand and mechanic.

Consider, the optimum promotion determination system 101 may receive the values of sales, catalogue, adsize as “1” for first six months and “0” for the next six months. Similarly, the values for brand and mechanic may be received as “1” for first four months, 8^{th} month and 12 month and as “0” for fifth, sixth, seventh, ninth, tenth and eleventh month. The optimum promotion determination system 101 may generate the constraint matrix based on the values of the five causal factors and the number of promotion activities to be organized in each month of the upcoming year. Further, the optimum promotion determination system 101 may identify the plurality of promotion sequences along with the gain value for each of the sequence using the predefined tehcnique. The optimum promotion determination system 101 may combine the gain matrix and the constraint matrix to identify the plurality of promotion sequences.

As shown in FIG. 3, promotion sequences 303 along with respective gain values are shown. Thereafter, the optimum promotion determination system 101 may determine the optimum promotion sequence from the plurality of promotion sequences 303 based on the gain values. In an embodiment, the optimum promotion determination system 101 may identify the predefined set of maximum gain values from the gain value of the plurality of promotion sequences 303 and may select one gain value from the predefined set of maximum gain values. Based on the selected gain value, the optimum promotion determination system 101 may determine the optimum promotion sequence from the plurality of promotion sequences 303. For example, as shown in FIG. 3, two sets of maximum gain values are identified as “2122.6” and “3122.7”. From the selected set of maximum gain value, the optimum promotion determination system 101 may select the gain value “3122.7” as the maximum gain value and may determine the third row in the plurality of promotion sequence 303 as the optimum promotion sequence.

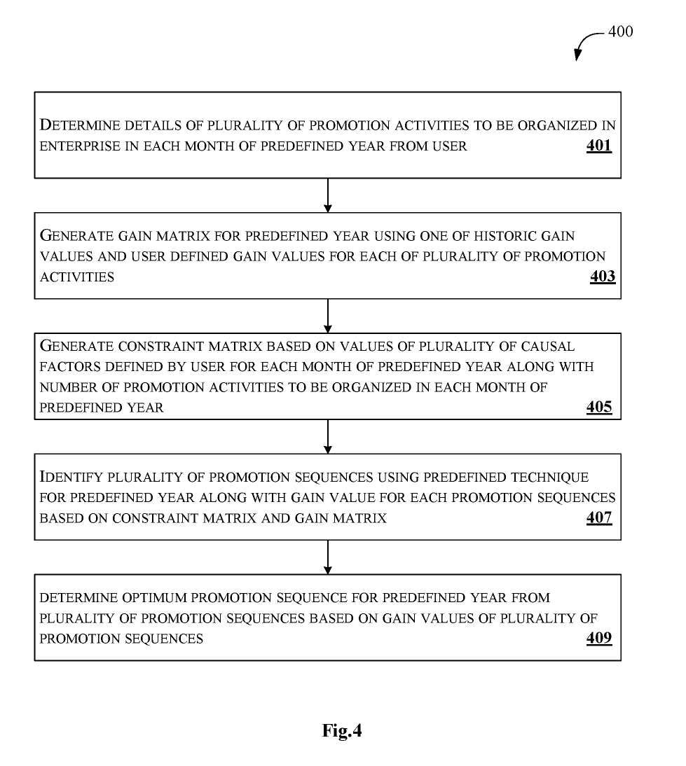

FIG. 4 illustrates a flowchart showing a method for determining an optimum promotion sequence for an enterprise in accordance with some embodiments of present disclosure.

As illustrated in FIG. 4, the method 400 includes one or more blocks for determining an optimum promotion sequence for an enterprise. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the details of the plurality of promotion activities are received by the receiving module 213 from the plurality of user devices 103. The plurality of promotion activities is to be organized in the enterprise in each month of the predefined year.

At block 403, the gain matrix for the predefined year is generated by the gain matrix generation module 215, using one of the historic gain values and the user-defined gain values for each of the plurality of promotion activities.

At block 405, the constraint matrix is generated, by the constraint matrix generation module 217, based on values of a plurality of causal factors defined by the user for each month of the predefined year along with number of promotion activities to be organized in each month of the predefined year.

At block 407 the promotion sequence identification module identifies the plurality of promotion sequences 219, using the predefined technique for the predefined year along with a gain value for each promotion sequence, based on the constraint matrix and the gain matrix. The plurality of promotion sequences includes one or more promotion activities from the plurality of promotion activities for each month of the predefined year.

At block 409, the optimum promotion sequence for the predefined year is determined, by the optimum promotion determination module 221, from the plurality of promotion sequences, based on the gain value of the plurality of promotion sequences.

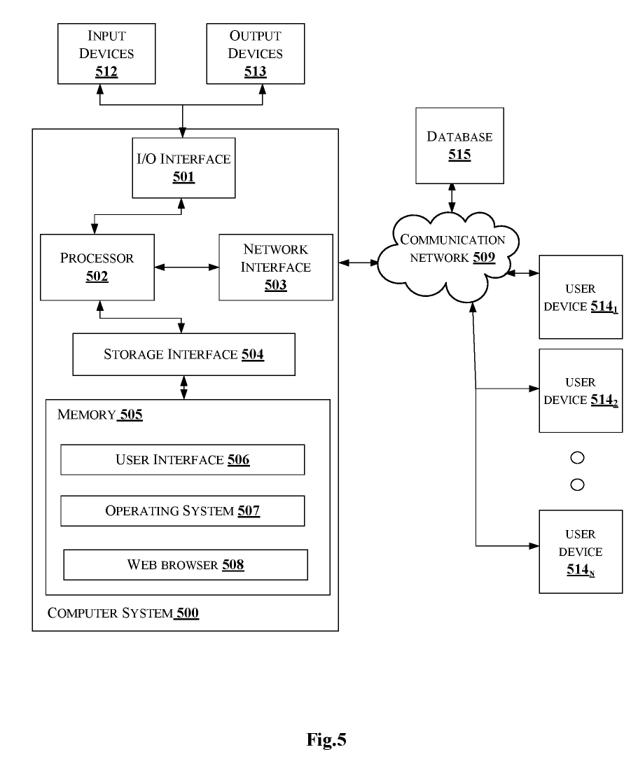

FIG. 5 illustrates a block diagram of an exemplary computer system 500 for implementing embodiments consistent with the present disclosure. In an embodiment, the computer system 500 may be used to implement the optimum promotion determination system 101. The computer system 500 may include a central processing unit (“CPU” or “processor”) 502. The processor 502 may include at least one data processor for determining an optimum promotion sequence for an enterprise. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via IO interface 501. The IO interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of the optimum promotion determination system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a user device 514₁, a user device 514₂ . . . and a user device 514_{N} (plurality of user devices device 514). Further, the computer system 500 may also communicate with a database 515. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement a web browser 508 stored program component. The web browser 508 may be a hypertext viewing application, for example MICROSOFT® INTERNET EXPLORER™ GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBE® FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™ MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure provides an optimum promotion and month combination.

An embodiment of the present disclosure helps in selecting optimal promotions while indirectly helping to cut promotion costs.

An embodiment of the present disclosure provides reduction in unnecessary promotion expenditure and boosts overall gain value.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of determining optimum promotion sequences for enterprises, the method implemented by one or more optimum promotion determination computing devices and comprising:
receiving details of a plurality of promotion activities to be organized in an enterprise in each month of a predefined year;
generating a gain matrix for the predefined year using one of historic gain values or user-defined gain values for each of the promotion activities;
generating a constraint matrix based on one or more values of a plurality of causal factors defined for each month of the predefined year along with a number of the promotion activities in each month of the predefined year;
identifying a plurality of promotion sequences, using a predefined technique, for the predefined year along with a gain value for each of the promotion sequences, based on the constraint matrix and the gain matrix, wherein the promotion sequences comprise one or more of the promotion activities for each month of the predefined year; and
determining an optimum promotion sequence for the predefined year, from the plurality of promotion sequences, based on the gain value of the plurality of promotion sequences.

2. The method as claimed in claim 1, wherein the promotion activities comprise a set of activities for presenting details of services provided by the enterprise through one or more mediums.

3. The method as claimed in claim 1, wherein the gain matrix represents a collective list of the plurality of promotion activities with respective gain value for each month of the predefined year.

4. The method as claimed in claim 1, wherein the causal factors comprise one or more parameters associated with the promotion activities.

5. The method as claimed in claim 1 further comprising regenerating the constraint matrix when one or more of the promotion activities change for a month.

6. The method as claimed in claim 1, wherein the predefined technique comprises an Integer Linear Programming (ILP) optimization technique.

7. The method as claimed in claim 1, further comprising:
identifying a predefined set of maximum gain values from the gain values of the promotion sequences;
selecting one gain value from the predefined set of maximum gain values; and
determining the optimum promotion sequence from the promotion sequences based on the selected gain value.

8. An optimum promotion determination computing device comprising memory comprising programmed instructions stored thereon and a processor configured to be capable of executing the stored programmed instructions to:
receive details of a plurality of promotion activities to be organized in an enterprise in each month of a predefined year;
generate a gain matrix for the predefined year using one of historic gain values or user-defined gain values for each of the promotion activities;
generate a constraint matrix based on one or more values of a plurality of causal factors defined for each month of the predefined year along with a number of the promotion activities in each month of the predefined year;
identify a plurality of promotion sequences, using a predefined technique, for the predefined year along with a gain value for each of the promotion sequences, based on the constraint matrix and the gain matrix, wherein the promotion sequences comprise one or more of the promotion activities for each month of the predefined year; and
determine an optimum promotion sequence for the predefined year, from the plurality of promotion sequences, based on the gain value of the plurality of promotion sequences.

9. The optimum promotion determination computing device of claim 8, wherein the promotion activities comprise a set of activities for presenting details of services provided by the enterprise through one or more mediums.

10. The optimum promotion determination computing device of claim 8, wherein the gain matrix represents a collective list of the plurality of promotion activities with respective gain value for each month of the predefined year.

11. The optimum promotion determination computing device of claim 8, wherein the causal factors comprise one or more parameters associated with the promotion activities.

12. The optimum promotion determination computing device of claim 8, wherein the processor is further configured to be capable of executing the stored programmed instructions to regenerate the constraint matrix when one or more of the promotion activities change for a month.

13. The optimum promotion determination computing device of claim 8, wherein the predefined technique comprises an Integer Linear Programming (ILP) optimization technique.

14. The optimum promotion determination computing device of claim 8, wherein the processor is further configured to be capable of executing the stored programmed instructions to:
identify a predefined set of maximum gain values from the gain values of the promotion sequences;
select one gain value from the predefined set of maximum gain values; and
determine the optimum promotion sequence from the promotion sequences based on the selected gain value.

15. A non-transitory computer readable medium having stored thereon instructions for determining optimum promotion sequences for enterprises comprising executable code which when executed by one or more processors, causes the processors to:
receive details of a plurality of promotion activities to be organized in an enterprise in each month of a predefined year;
generate a gain matrix for the predefined year using one of historic gain values or user-defined gain values for each of the promotion activities;
generate a constraint matrix based on one or more values of a plurality of causal factors defined for each month of the predefined year along with a number of the promotion activities in each month of the predefined year;
identify a plurality of promotion sequences, using a predefined technique, for the predefined year along with a gain value for each of the promotion sequences, based on the constraint matrix and the gain matrix, wherein the promotion sequences comprise one or more of the promotion activities for each month of the predefined year; and
determine an optimum promotion sequence for the predefined year, from the plurality of promotion sequences, based on the gain value of the plurality of promotion sequences.

16. The non-transitory computer readable medium of claim 15, wherein the promotion activities comprise a set of activities for presenting details of services provided by the enterprise through one or more mediums.

17. The non-transitory computer readable medium of claim 15, wherein the gain matrix represents a collective list of the plurality of promotion activities with respective gain value for each month of the predefined year.

18. The non-transitory computer readable medium of claim 15, wherein the causal factors comprise one or more parameters associated with the promotion activities.

19. The non-transitory computer readable medium of claim 15, wherein the executable code when executed by the processors further causes the processors to regenerate the constraint matrix when one or more of the promotion activities change for a month.

20. The non-transitory computer readable medium of claim 15, wherein the predefined technique comprises an Integer Linear Programming (ILP) optimization technique.

21. The non-transitory computer readable medium of claim 15, wherein the executable code when executed by the processors further causes the processors to:
identify a predefined set of maximum gain values from the gain values of the promotion sequences;
select one gain value from the predefined set of maximum gain values; and
determine the optimum promotion sequence from the promotion sequences based on the selected gain value.
